(19) United States
(12) Patent Application Publication
(10) Pub. No.: US 2021/0235194 A1
(43) Pub. Date: Jul. 29, 2021

(54) RESONATING LOUDSPEAKERS AND RELATED SYSTEMS AND METHODS

(71) Applicant: Symphonova, Ltd., London (GB)

(72) Inventor: Shelley Katz, Bexhill on Sea (GB)

(73) Assignee: Symphonova, Ltd., London (GB)

(21) Appl. No.: 15/734,963

(22) PCT Filed: Jun. 11, 2019
(86) PCT No.: PCT/EP2019/065151

§ 371 Date: Dec. 3, 2020

Related U.S. Application Data
(60) Provisional application No. 62/683,438, filed on Jun. 11, 2018.

(51) Int. Cl. H04R 7/04; H04R 7/26; H04R 7/10; H04R 1/28

(52) U.S. Cl. CPC H04R 7/045; H04R 7/26; H04R 2307/025; H04R 1/288; H04R 2307/207; H04R 7/10

(57) ABSTRACT

The present application relates to an improved flat panel loudspeaker design. According to some aspects, the loudspeaker may include a flat panel, and a driving unit coupled to the flat panel configured to produce resonant behavior in the flat panel according to an electrical signal received by the driving unit. One or more pieces of reticulated foam may be mechanically coupled to the flat panel, and in some cases may cover the entire surface of the flat panel.

### BACKGROUND

A loudspeaker is a type of transducer that converts an electrical signal into sound. This conversion is produced by providing the electrical signal to a driving unit, which produces motion of a magnetic coil according to the electrical signal. This motion is commonly conveyed to a stiff cone that is intended to be moved entirely and as a single body in synchrony with the driving unit. The motion of the driving unit may also be conveyed to a vibrating element, which moves in the air and produces sound waves. Most commonly, elements intended for whole-body motion are lightweight cone or dome-shaped diaphragms which the driving unit may move.

In some loudspeaker designs, the vibrating element is a flat panel to which a driving unit is mechanically coupled. When the driving unit moves it induces the panel to resonate by flexing, typically within a housing.

### SUMMARY

The present application relates to an improved flat panel loudspeaker design. According to some embodiments, the loudspeaker may include a flat panel, and a driving unit coupled to the flat panel configured to produce resonant behavior in the flat panel according to an electrical signal received by the driving unit. One or more pieces of reticulated foam may be mechanically coupled to the flat panel, and in some cases may cover the entire surface of the flat panel.

According to some aspects, a loudspeaker may be provided, comprising a panel, a driving unit mechanically coupled to the panel and configured to produce resonant behavior in the panel according to an electrical signal received by the driving unit, and at least one piece of reticulated foam mechanically coupled to the panel.

According to some embodiments, the panel is a flat panel.

According to some embodiments, the panel is a curved panel.

According to some embodiments, the at least one piece of reticulated foam comprises a first sheet of reticulated foam mechanically coupled to a first side of the panel and a second sheet of reticulated foam mechanically coupled to a second side of the panel.

According to some embodiments, the at least one piece of reticulated foam is coupled to an entire face of the panel.

According to some embodiments, the loudspeaker further comprises one or more fasteners attached to and compressing the at least one piece of reticulated foam.

According to some embodiments, the plurality of fasteners are positioned to amplify resonant behavior of the panel at a subset of frequencies below 150 Hz.

According to some embodiments, the loudspeaker further comprises a plurality of rigid pins contacting the at least one piece of reticulated foam and/or the panel.

According to some embodiments, the at least one piece of reticulated foam is attached to the panel via a layer of adhesive.

According to some embodiments, the loudspeaker does not comprise a frame mechanically supporting the panel.

According to some embodiments, the at least one piece of reticulated foam has a thickness greater than a thickness of the panel.

According to some embodiments, the thickness of the at least one piece of reticulated foam is at least twice the thickness of the panel.

According to some embodiments, the panel comprises a honeycomb core material.

According to some embodiments, the at least one piece of reticulated foam comprises polyurethane foam.

According to some embodiments, the at least one piece of reticulated foam has a density between 20 pores per inch and 60 pores per inch.

According to some aspects, a system may be provided comprising the loudspeaker and a digital signal processing (DSP) unit connected to the driving unit.

According to some embodiments, the digital signal processing (DSP) unit is configured to increase and/or decrease signal power in one or more frequency bands.

According to some embodiments, the panel is a first panel, the loudspeaker further comprises a second panel, and the at least one piece of reticulated foam comprises a first piece of reticulated foam coupled to the first panel and a second piece of reticulated foam coupled to the second panel.

According to some embodiments, the driving unit is a first driving unit, and the loudspeaker further comprises a second driving unit coupled to the second panel, and a non-resonant fabric coupled to the first panel and to the second panel.

The foregoing embodiments may be implemented with any suitable combination of aspects, features, and acts described above or in further detail below. These and other aspects, embodiments, and features of the present teachings can be more fully understood from the following description in conjunction with the accompanying drawing

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIGS. 1A-1B depict sound produced from a whole-body loudspeaker and a resonating loudspeaker, respectively, according to some embodiments;

FIGS. 2A-2B depict side and front views, respectively, of an illustrative resonating loudspeaker design, according to some embodiments;

FIGS. 3A-3C depicts top, side and perspective views, respectively, of a resonating loudspeaker comprising foam mechanically coupled to a flat panel resonating element, according to some embodiments;

FIG. 4A depicts a portion of a flat panel resonating loudspeaker comprising foam mechanically coupled to a resonating element in which a clip is attached to the foam, according to some embodiments;

FIG. 4B depicts a portion of a flat panel resonating loudspeaker comprising foam mechanically coupled to a resonating element in which a pin is arranged to restrict motion of the panel, according to some embodiments;

FIGS. 5A-5B depict an illustrative frequency-power spectrum of a flat panel loudspeaker comprising foam mechanically coupled to a resonating element before and after tuning through mechanical restriction of the foam, according to some embodiments; and

FIG. 6 depicts an illustrative use case of a resonating loudspeaker as described herein, according to some embodiments.

### DETAILED DESCRIPTION

As discussed above, some loudspeaker (or simply “speaker”) designs include a resonating element, which is often a flat panel. These types of loudspeakers (referred to henceforth as “resonating loudspeakers”) may include a resonating element made from, for example, polystyrene, plastic, glass fiber, or wood. Resonating loudspeakers can often create a more natural sound than loudspeakers containing one or more vibrating dome and/or cone-shaped diaphragms, in part because the sound emanates from across all, or most of, the panel rather than emanating outward from the interior of a dome or cone.

In a speaker that operates through vibration of a dome- or cone-shaped diaphragm (referred to henceforth as “whole-body loudspeakers”), resonances are actively avoided as much as possible by forming the diaphragm from stiff, light materials. In a loudspeaker system, multiple diaphragms are often employed with each diaphragm being configured to produce sound across a band of frequencies in which the diaphragm does not resonate. For instance, a tweeter is a type of speaker that produces high frequency sound and that may exhibit resonant frequencies at lower frequencies, outside of the range of sound frequencies that the tweeter is configured to output. The types of sound waves produced by a stiff, cone-shaped diaphragm are coherent waves that are produced through whole-body motion of the diaphragm.

In contrast, a resonating loudspeaker produces sound through deliberate resonance of a resonating element. This type of approach produces incoherent (and therefore non-directional) sound waves that are produced by exciting multiple resonant modes of the resonating element.

In addition, sound waves produced from resonating loudspeakers are typically less restricted from propagating than sound waves produced within a speaker enclosed within a box, because in a resonating loudspeaker the sound waves can travel outward from both sides of the panel and do not bounce around within a box, which affects the quality of the sound.

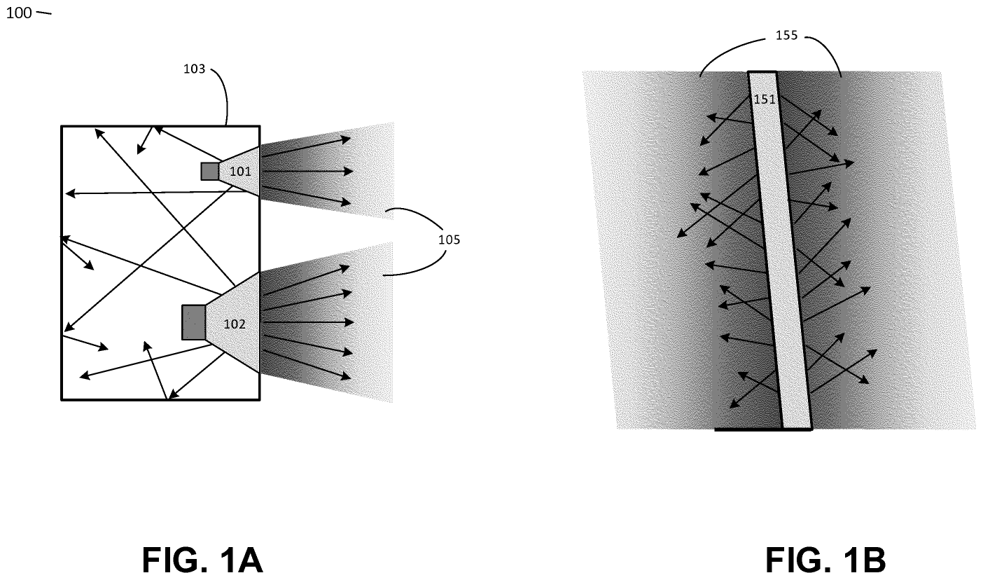

FIGS. 1A and 1B provide an illustrative depiction of how sound produced from resonating loudspeakers and whole-body loudspeakers differs in these respects. As shown in FIG. 1A, speakers 101 and 102 of whole-body loudspeaker system 100 produce sound from cone-shaped diaphragms. The diaphragms of the speakers are supported by the enclosure 103 so that each diaphragm can vibrate in a piston-like fashion and produce sound. This sound is produced in numerous directions, and the sound produced toward the apex of the cone is contained within an enclosure 103 to avoid this sound interfering with sound 105, which comprises coherent sound waves produced outward from the speaker. In FIG. 1A, the arrows represent illustrative paths taken by sound waves produced by the loudspeakers 101 and 102. Shaded regions 105 depict the sound that is output into the environment from the device 100.

FIG. 1B illustrates a resonating loudspeaker 151. In the example of FIG. 1B, the arrows represent illustrative paths taken by the incoherent, directionless sound waves produced by one or more resonant modes of the resonating loudspeaker 151, and shaded regions 155 depict sound that is output into the environment.

Despite the above-described advantages of resonating loudspeakers, there are nonetheless several challenges presented by such devices. While the resonating elements in such speakers are not enclosed in the same manner as typical cone or dome-shaped diaphragms, a frame is still conventionally necessary to hold the resonating element. Resonating elements in resonating loudspeakers are often several feet long, and as a result the frames to hold those elements and associated electronics are typically bulky and heavy. In addition, whilst the frames of resonating speakers do not affect the sound quality of the resonating elements to the same extent as enclosed whole-body vibrating diaphragms, the presence of a rigid body coupled to the resonating element inevitably affects the sound quality to some degree. Moreover, the size and weight of the frames represents a large fraction of the total cost of a resonating speaker, both with respect to the materials needed and the time needed to produce the frame.

The inventor has recognized and appreciated techniques for producing a lightweight resonating loudspeaker by mechanically coupling foam to a resonating element. Attaching a material like foam, known to be an effective dampener of sound waves, to a resonating element would generally be expected to dramatically reduce the quality of the sound produced from the speaker. The inventor has recognized, however, that foam may be mechanically attached to a resonating element in such a way as to produce sound quality that is commensurate with, or even better than, conventional resonating loudspeakers. Moreover, the resulting design may include a sufficient quantity of foam so as to provide sufficient mechanical support for the loudspeaker, without a frame being necessary. As a result, the loudspeaker design of the present disclosure may address one or more of the above-referenced challenges faced with conventional resonating loudspeaker design.

According to some embodiments, a resonating loudspeaker may comprise a sheet of foam mechanically coupled to one side of a resonating element, or two sheets of foam mechanically coupled to opposing sides of a resonating element. The foam sheet(s) may be glued or otherwise affixed to the resonating element. In some embodiments, either or both of the foam sheets may have a thickness that is greater than the thickness of the resonating element. In some embodiments, an exterior of the foam may be coated or otherwise surrounded, in whole or in part, with a protective layer such as a protective film.

According to some embodiments, a resonating loudspeaker may comprise reticulated foam mechanically coupled to a resonating element. It has been recognized by the inventor that reticulated foam may produce superior sound quality to open cell or closed cell foams when mechanically coupled to a resonating element in a resonating loudspeaker.

According to some embodiments, a resonating element may be mechanically restricted at discrete locations by, for instance, attaching additional material to the foam and/or the resonating element at these locations and/or by pinning or otherwise restricting motion of the foam and/or the resonating element. In some cases, these discrete locations may include, or may be limited to, locations around the perimeter of the foam and/or the resonating element. The inventor has recognized that restricting motion of the foam and/or the resonating element in this manner can alter the manner in which acoustic energy propagates through the loudspeaker, such that particular resonant behavior can be increased or mitigated by selecting a suitable location at which to restrict motion. In particular, an amount of acoustic energy produced at one or more frequencies may be adjusted (increased or decreased) by restricting motion of the foam and/or the resonating element at discrete locations. In this manner, mechanically restricting motion of the foam and/or resonating element at these locations may be considered a step of “tuning” the resonating loudspeaker (although other, distinct, tuning steps may also be performed in some cases).

According to some embodiments, a resonating loudspeaker may be coupled to a digital signal processor (DSP) programmed to alter the resonant behavior of the loudspeaker. In this manner, although the resonating loudspeaker may produce less acoustic power than desired at particular frequencies (or more acoustic power than desired at particular frequencies), the DSP may suitably alter audio signals provided to the loudspeaker so that it produces a more desirable power spectrum. A DSP may be employed in this manner as an alternative to, or in addition to, mechanically restricting the foam as described above.

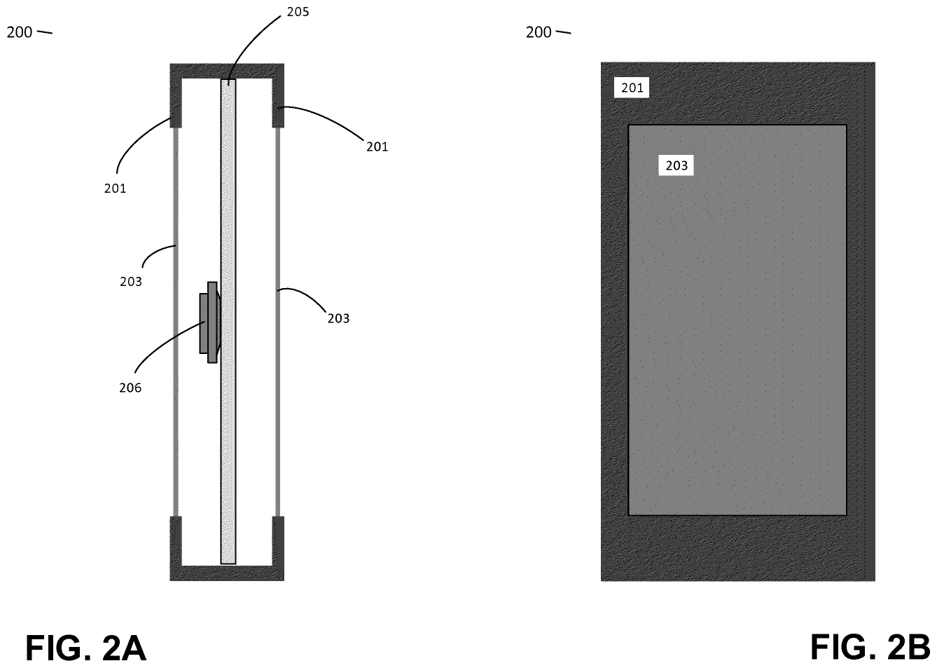

FIGS. 2A-2B depict side and front views, respectively, of an illustrative resonating loudspeaker design, according to some embodiments. Resonating loudspeaker 200 includes a resonating flat panel 205 (shown in the cross-sectional side view of FIG. 2A), a driving unit 206, a frame 201 which mechanically supports the components, and a grille 203 which serves to protect the interior of the loudspeaker whilst allowing sound to propagate outward.

In operation, the driving unit 206 of resonating loudspeaker 200 vibrates the resonating flat panel 205. Electronic signals may be provided to the driving unit 206 (e.g., via cables and/or other electronics not pictured in FIGS. 2A-2B) which cause the driving unit to move according to the signals and generate vibrations according to one or more vibrational modes of the panel 205. In some cases, the resonating panel 205 may be mounted to supports arranged to suspend the panel whilst minimizing any effect on its ability to vibrate (not pictured).

In the description that follows below, illustrative examples of a resonating element in a resonating loudspeaker are provided that include a flat panel as a resonating element. It will be appreciated that in some devices a resonating element may be a panel that is not flat, such as a curved panel, a spherical panel (being a portion of a sphere, or a full sphere), a pyramidal shape, or any other suitable shape. The techniques described below may apply equally to any such shapes and indeed to any other shape that may be envisioned or desired as a resonating element, as the techniques for mechanically coupling foam to a resonating element are not limited to any particular shape of resonating element. As such, it will be appreciated that all below discussions relating to a “flat panel” loudspeaker may apply equally to a resonating loudspeaker in which the resonating element is shaped differently than a flat panel.

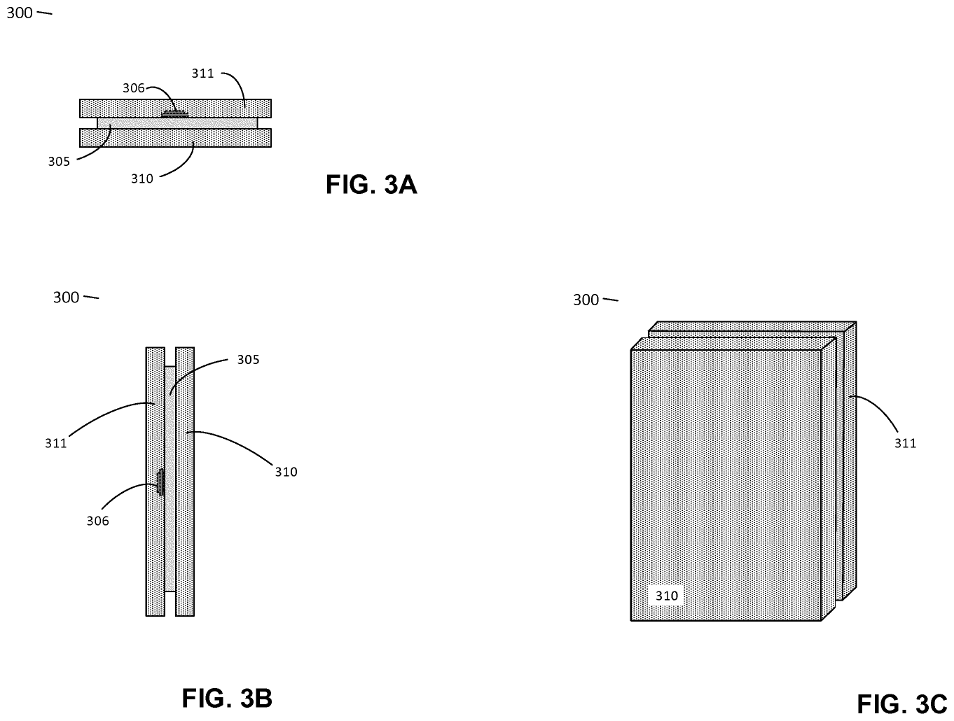

As discussed above, the inventor has recognized and appreciated techniques for producing a lightweight resonating loudspeaker by mechanically coupling foam to the resonating element. An illustrative example of such a loudspeaker is shown in FIGS. 3A-3C. Resonating loudspeaker 300 is shown in top, side and perspective views in FIGS. 3A, 3B and 3C, respectively. In operation, a driving unit 306 of the loudspeaker excites resonances of the resonating element 305, which in the example of FIGS. 3A-3C is a flat panel resonating element. In some cases, the driving unit 306 may cause resonant behavior of the foam 310 and/or 311, such that sound produced from the loudspeaker may be produced from some combination of the resonating element 305 and/or the foam 310 and 311.

In the example of FIGS. 3A-3C, foam sheets 310 and 311 are coupled to a panel 305. A driving unit 306 is located within the interior of the device and attached to the panel. The driving unit 306 is shown in dashed lines since FIGS. 3A-3C are external views of the loudspeaker and the driving unit is located within the loudspeaker and not visible from the exterior (in the example of FIGS. 3A-3C the driving unit is attached to the center of a face of the panel 305). In some cases, multiple drive units may be attached to the panel 305. One illustrative driving unit suitable for use in the example of FIGS. 3A-3C may be the Tectonic TEAX25C10-8/HS.

In some embodiments, the flat panel resonating loudspeaker 300 may have a sufficient mass of foam compared with a mass of the flat panel and other components to be mechanically supported without it being necessary to add a rigid frame. In some cases, however, a frame may nonetheless be added but may be lighter and/or smaller than the frame that would conventionally be necessary to support a conventional flat panel loudspeaker of commensurate size and shape.

According to some embodiments, foam sheets 310 and 311 are coupled to the panel 305 via an adhesive, such as contact cement. It will be appreciated that the foam sheets may be mechanically coupled to the panel via any suitable technique, at least some of which may not involve the foam directly touching the panel. As such, references to mechanical coupling between foam and a resonating element herein are not limited to arrangements in which the foam contacts the resonating element directly, but may include instances in which the foam is affixed in some way to the resonating element such that the two components are mechanically attached to one another. For instance, a layer of adhesive may cover, or substantially cover, a resonating element and foam may be attached to the adhesive. In such cases, the foam may be referred to within the scope of this disclosure as being mechanically coupled to the resonating element.

According to some embodiments, foam sheet 310 and/or foam sheet 311 may comprise, or may consist of, reticulated foam. In some embodiments, reticulated foam may comprise, or be formed from, polyurethane. In some embodiments, the reticulated foam may be post treated with a material different from the material from which the foam is formed. For instance, a polyurethane foam may be post treated with polyvinyl chloride (PVC). One illustrative example of a suitable reticulated foam for forming foam sheet 310 and/or foam sheet 311 is Improcel RS60 available from Vitec Composite Systems. In some cases, either or both foam sheets may be acoustically transparent.

In some embodiments, reticulated foam that forms part or all of foam sheet 310 and/or foam sheet 311 may have a nominal pore size of greater than or equal to 10 pores per inch (ppi), 20 ppi, or 30 ppi. In some embodiments, the reticulated foam may have a nominal pore size of less than or equal to 80 ppi, 60 ppi, or 50 ppi. Any suitable combinations of the above-referenced ranges are also possible (e.g., a nominal pore size of greater or equal to 20 ppi and less than or equal to 50 ppi, etc.). A preferred range for the nominal pore size of the reticulated foam may be between 30 ppi and 60 ppi.

In some embodiments, reticulated foam that forms part or all of foam sheet 310 and/or foam sheet 311 may have a thickness of greater than or equal to 1 mm, 2 mm, 4 mm, 6 mm, or 10 mm. In some embodiments, the reticulated foam may have a thickness of less than or equal to 20 mm, 15 mm, 10 mm, or 8 mm. Any suitable combinations of the above-referenced ranges are also possible (e.g., a thickness of between 4 mm and 10 mm, etc.).

According to some embodiments, flat panel 305 may comprise a lightweight rigid material, such as, but not limited to, PVC, wood, polystyrene, plastic, glass fiber, or paper. In some embodiments, flat panel 305 may comprise, or may be composed of, a honeycomb material such as Nomex® aramid honeycomb, which is a core material formed from phenolic resin bonded nomex paper.

In some embodiments, flat panel 305 may comprise a first material to which a film is applied, such as a polyester film. In some embodiments, flat panel 305 may comprise a honeycomb core material and a film such as Melinex® polyester film applied to the surface of the core material.

In some embodiments, flat panel 305 may have a thickness of greater than or equal to 1 mm, 3 mm, or 5 mm. In some embodiments, the flat panel may have a thickness of less than or equal to 10 mm, 6 mm, 5 mm, or 4 mm. Any suitable combinations of the above-referenced ranges are also possible (e.g., a thickness of greater or equal to 3 mm and less than or equal to 5 mm, etc.).

It will be appreciated that a flat panel loudspeaker in which only a single side of the flat panel is attached to a foam sheet may also be envisioned. All aspects of the flat panel, driving unit and foam sheets discussed above in relation to FIGS. 3A-3C may equally apply to such a loudspeaker.

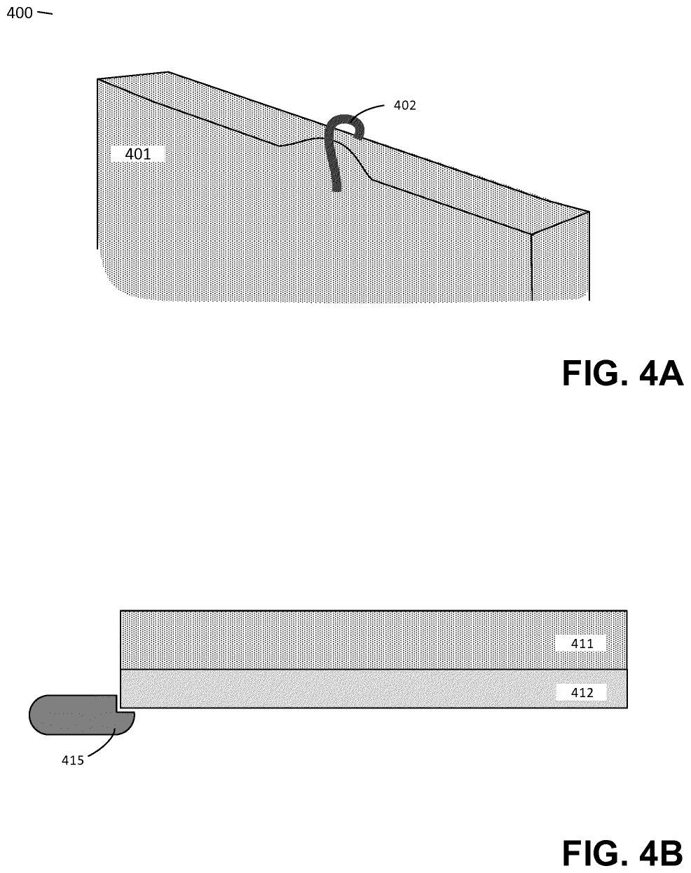

As discussed above, the inventor has recognized that restricting motion of the foam and/or the resonating panel of a resonating panel loudspeaker (e.g., the loudspeaker 300 shown in FIGS. 3A-3C) can alter the manner in which acoustic energy propagates through the loudspeaker, such that particular resonant behavior can be increased or mitigated by selecting a suitable location at which to restrict motion. FIGS. 4A and 4B depict two illustrative techniques for restricting motion in this way. These examples should not be viewed as limiting, since numerous techniques for achieving the same goal may be envisioned.

FIG. 4A depicts a portion of a flat panel resonating loudspeaker comprising foam mechanically coupled to a resonating element in which a clip is attached to the foam, according to some embodiments. In the example of FIG. 4A, only a portion of a loudspeaker 400 is shown for clarity. Specifically a piece of reticulated foam 401 is depicted with a clip 402 attached to a part of the exterior of the foam which acts as a vibrational damping element. It will be appreciated that in the example of FIG. 4A, a flat panel resonating element may be attached to the foam 401 though not shown in the figure, and that the clip 402 may in some cases be affixed to both a piece of reticulated foam and an associated panel.

According to some embodiments, clip 402 may comprise a rigid material such as steel. For instance, the clip 402 may be a steel hitch pin or a steel cotter pin. In some embodiments, the clip 402 may comprise plastic.

FIG. 4B depicts a portion of a flat panel loudspeaker comprising foam mechanically coupled to a resonating element in which a pin is arranged to restrict motion of the panel, according to some embodiments. In the example of FIG. 4B, a rigid pin 415 is arranged adjacent to an edge of flat panel 412, which is mechanically coupled to foam 411. The pin 415 has the shape of a capsule with a notch removed from one corner and is configured to act as a vibrational damping element.

The pin 415 may be affixed in place such that vibrational motion of the panel 412 and foam 411 is restricted at least at the point of contact between the pin and the panel 412. According to some embodiments, pin 415 may be mounted on, or within, a frame surrounding some or all of the flat panel 412. For instance, pin 415 may be arranged within a hole formed into such a frame. In some embodiments, pin 415 may be affixed to the panel 412 via an adhesive and/or other means. In some embodiments, pin 415 may comprise, or may consist of, steel or another suitable metal.

It will be appreciated that a number of pins 415 may be included within a flat panel loudspeaker in various locations, and that some pins may be arranged adjacent to a flat panel and/or some pins may be arranged adjacent to a piece of foam.

One illustrative alternative to the depicted examples of FIGS. 4A and 4B for restricting motion of foam and/or a panel resonating element in a flat panel loudspeaker is to affix a flexible material to the panel and/or foam. For instance, a piece of neoprene rubber (e.g., a neoprene rubber having a Shore value of at least 60) may be folded around the panel and adhered or otherwise affixed to the panel. As another example, an elastic material such as a pressure sensitive adhesive (e.g., blu tack or sticky tack) may be affixed to the panel and/or foam as a vibrational damping element.

The above illustrative techniques for restricting the vibrational motion of a flat panel and/or foam are not limiting, and may be combined with one another and/or with other techniques. Moreover, the techniques are not limited to the particular implementations described in the above examples. For instance, the pin 415 may be installed within a flat panel loudspeaker in which foam is mechanically coupled to opposing sides of a panel, as the particular arrangement of elements shown in FIG. 4B is not so limiting.

Irrespective of the particular technique(s) employed to restrict the vibrational motion of a flat panel and/or foam, locations for such restriction may be selected in a number of ways. As discussed above, the inventor has recognized that restricting motion of the foam and/or the resonating panel of a resonating panel loudspeaker (e.g., the loudspeaker 300 shown in FIGS. 3A-3C) can alter the manner in which acoustic energy propagates through the loudspeaker, such that particular resonant behavior can be increased or mitigated by selecting a suitable location at which to restrict motion. As such, one manner in which one or more locations for a vibrational damping element may be selected is by manually restricting the foam and/or panel (e.g., by pinching the foam and/or panel with fingers) and to identify an effect upon the acoustics of the loudspeaker. This process notwithstanding, it may be expected that desirable locations at which to restrict vibrations of the foam and/or panel may be the same, or approximately the same, for two flat panel loudspeakers that have the same dimensions and materials for the foam and the resonating panel. As such, this tuning process may not necessarily need to be performed for fabrication of every flat panel loudspeaker.

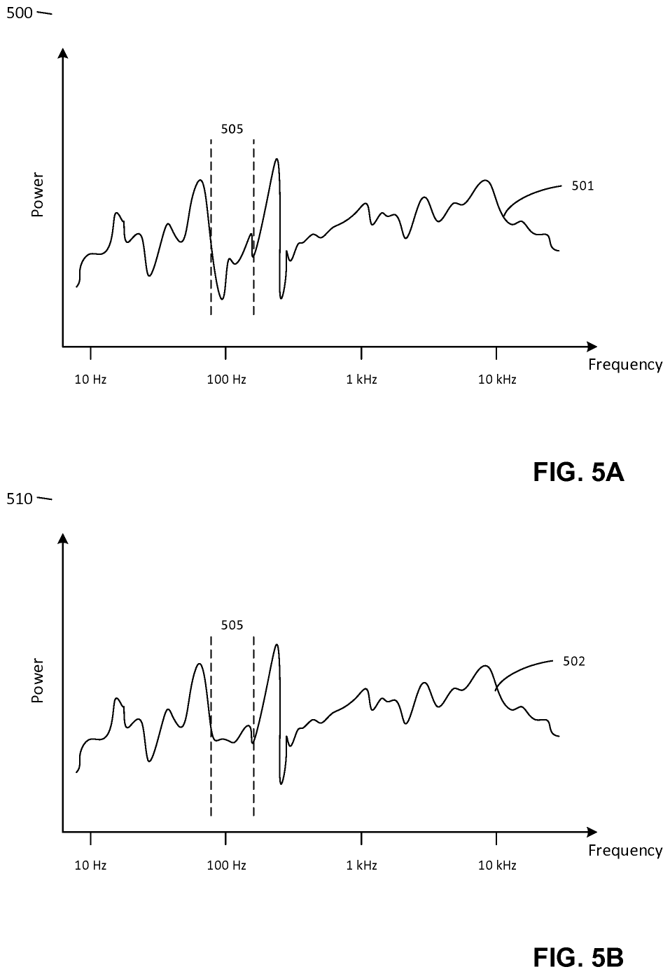

To illustrate qualitatively the type of effect a vibrational damping element may have on a flat panel loudspeaker, FIGS. 5A-5B depict a frequency-power spectrum of a flat panel loudspeaker comprising foam mechanically coupled to a resonating element before and after tuning through mechanical restriction of the foam, according to some embodiments. In the example of FIGS. 5A-5B, a measured power spectrum illustrating an amount of acoustic power present in sound output from a flat panel loudspeaker as a function of frequency is shown. Such a power spectrum may be produced, for example, by recording or otherwise capturing sound produced from a flat panel loudspeaker and generating a Fast Fourier Transform of the sound.

In FIG. 5A, the power spectrum of a particular flat panel loudspeaker is shown with curve 501. It will be noted that in a particular frequency window 505 there is a lower amount of power being produced, represented by a trough at just under 100 Hz. By a suitable placement of a vibrational damping element (which may include any suitable element, including any of the above examples of a clip, pin, adhesive, rubber, etc.) the size of this trough may be adjusted. In such a case, the resulting power spectrum may be as in the example of FIG. 5B, in which the power spectrum 502 is identical to power spectrum 501 except for changes within the frequency window 505, wherein the power at those frequencies has been adjusted to be closer to an average power.

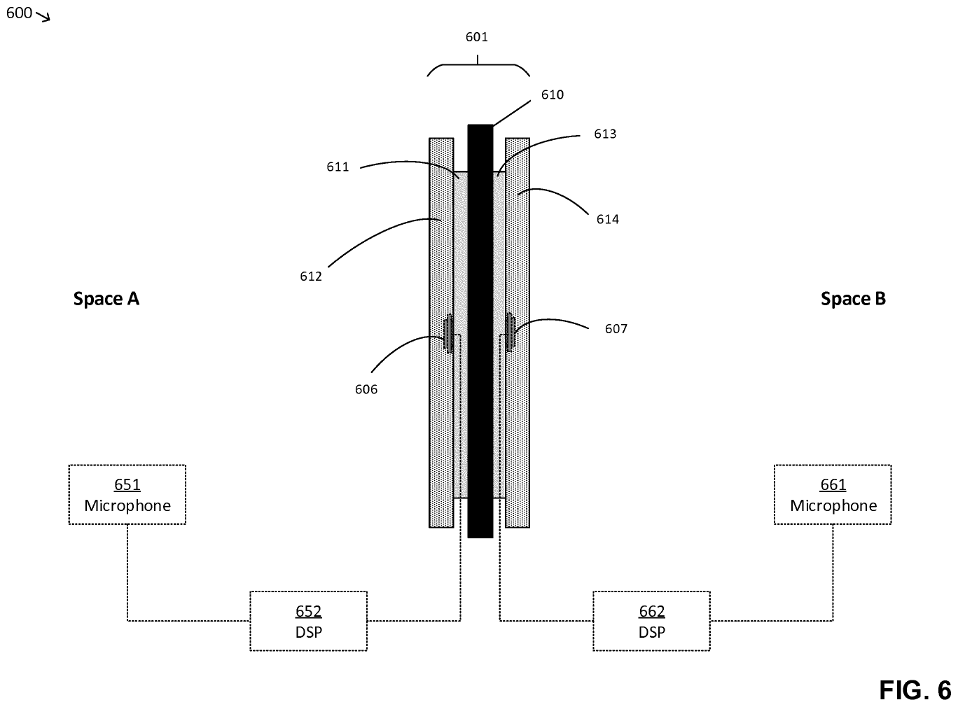

FIG. 6 depicts an illustrative example of a use case in which a resonating loudspeaker as described herein may be deployed, according to some embodiments. System 600 includes a device 601 comprising two flat panel resonating elements 611 and 613, each coupled to respective foam sheets 612 and 614. Resonating elements 611 and 613 are each coupled to a driving unit 606 and 607, respectively. An acoustically inert material 610 is arranged between the two resonating elements 611 and 613, which may allow the device 601 to function as two independent loudspeakers, with elements 606, 611 and 612 forming one loudspeaker that may produce sound in Space A, and elements 607, 613 and 614 forming a separate and distinct loudspeaker that may produce sound in Space B. Acoustically inert material 610 may, for instance, comprise a non-resonant fabric such as rubber.

The various characteristics and materials of corresponding elements discussed above in relation to FIGS. 3A-3C may also be applied to the elements of FIG. 6. For instance, each of the flat panel resonating panels 611 and 612 may comprise a honeycomb core material and a film such as Melinex® polyester film applied to the surface of the core material, and each of the foam sheets 612 and 614 may comprise reticulated foam.

In the example of FIG. 6, the device 601 may optionally be driven to produce a quiet ambient environment in Space A and/or in Space B via the microphones 651 and 661, and the coupled Digital Signal Processors (DSPs) 652 and 662. In particular, by capturing ambient sound in a respective space (e.g., microphone 651 captures ambient sound in Space A), a sound signal thus produced from the microphone may be processed by the associated DSP to produce sound into that space configured to dampen the ambient sound via the loudspeaker represented by elements 611, 612 and 606. A result of such a process may produce a noise-canceling effect in a given space. Since the two illustrated spaces are separated using the acoustically inert material 610, the device 601 may be used as a dividing wall or partition between spatial regions, such as portions of a restaurant or other public space. Alternatively, or additionally, the DSPs may be operated to output an additional audio source, such as music, through the respective resonating loudspeakers. In some embodiments, processing sound by either or both DSPs may comprise adding spatial information into sound captured from a space, then providing the modified sound (i.e., the captured sound supplemented with the spatial information) into the space.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

One illustrative alternative embodiment is to utilize reticulated foam as a resonating element. In such an approach, a resonating loudspeaker may not include a panel in the conventional sense, but may rather include a piece of foam sufficiently dense and/or stiff to propagate sound waves from a driving element to which it is coupled.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A loudspeaker, comprising:
a panel;
a driving unit mechanically coupled to the panel and configured to produce resonant behavior in the panel according to an electrical signal received by the driving unit; and
at least one piece of reticulated foam mechanically coupled to the panel.

2. The loudspeaker of claim 1, wherein the panel is a flat panel.

3. The loudspeaker of claim 1, wherein the panel is a curved panel.

4. The loudspeaker of claim 1, wherein the at least one piece of reticulated foam comprises a first sheet of reticulated foam mechanically coupled to a first side of the panel and a second sheet of reticulated foam mechanically coupled to a second side of the panel.

5. The loudspeaker of claim 1, wherein the at least one piece of reticulated foam is coupled to an entire face of the panel.

6. The loudspeaker of claim 1, further comprising one or more fasteners attached to and compressing the at least one piece of reticulated foam.

7. The loudspeaker of claim 6, wherein the plurality of fasteners are positioned to amplify resonant behavior of the panel at a subset of frequencies below 150 Hz.

8. The loudspeaker of claim 1, further comprising a plurality of rigid pins contacting the at least one piece of reticulated foam and/or the panel.

9. The loudspeaker of claim 1, wherein the at least one piece of reticulated foam is attached to the panel via a layer of adhesive.

10. The loudspeaker of claim 1, wherein the loudspeaker does not comprise a frame mechanically supporting the panel.

11. The loudspeaker of claim 1, wherein the at least one piece of reticulated foam has a thickness greater than a thickness of the panel.

12. The loudspeaker of claim 11, wherein the thickness of the at least one piece of reticulated foam is at least twice the thickness of the panel.

13. The loudspeaker of claim 1, wherein the panel comprises a honeycomb core material.

14. The loudspeaker of claim 1, wherein the at least one piece of reticulated foam comprises polyurethane foam.

15. The loudspeaker of claim 1, wherein the at least one piece of reticulated foam has a density between 20 pores per inch and 60 pores per inch.

16. A system comprising the loudspeaker of claim 1 and a digital signal processing (DSP) unit connected to the driving unit.

17. The system of claim 16, wherein the digital signal processing (DSP) unit is configured to increase and/or decrease signal power in one or more frequency bands.

18. The loudspeaker of claim 1, wherein the panel is a first panel, the loudspeaker further comprises a second panel, and the at least one piece of reticulated foam comprises a first piece of reticulated foam coupled to the first panel and a second piece of reticulated foam coupled to the second panel.

19. The loudspeaker of claim 18, wherein the driving unit is a first driving unit, and the loudspeaker further comprises:
a second driving unit coupled to the second panel; and
a non-resonant fabric coupled to the first panel and to the second panel.
